(19) United States
(12) Patent Application Publication
(10) Pub. No.: US 2016/0084064 A1
(43) Pub. Date: Mar. 24, 2016

(54) DETERMINING A SHAPE OF A DOWNHOLE OBJECT

(71) Applicant: HALLIBURTON ENERGY SERVICES, INC., Houston, TX (US)

(72) Inventor: Jack Gammill Clemens, Fairview, TX (US)

(21) Appl. No.: 14/888,818

(22) PCT Filed: Jul. 2, 2013
(86) PCT No.: PCT/US13/49142

§ 371 Date: Nov. 3, 2015

(51) Int. Cl. E21B 47/00; G01B 5/20; E21B 31/12

(52) U.S. Cl. CPC E21B 47/00; E21B 31/12; G01B 5/20

(57) ABSTRACT

A downhole tool includes a housing including a base and an end open to an exterior of the housing opposite the base; and a plurality of moveable members at least partially enclosed within the housing, at least a portion of the moveable members contactingly mounted in the housing against at least one of a friction member or an adjacent moveable member, each moveable member in the portion of moveable members configured to translate between a first position extended a first distance from the base and a second position extended a variable second distance from the base less than the first distance based on contact of the moveable member with a downhole object.

### CROSS-REFERENCE TO RELATED APPLICATIONS

This application is a U.S. National Phase Application under 35 U.S.C. §371 and claims the benefit of priority to International Patent Application No. PCT/US2013/049142, filed Jul. 2, 2013, the contents of which are hereby incorporated by reference.

### TECHNICAL BACKGROUND

This disclosure relates to determining a shape of a downhole object.

### BACKGROUND

In oil field operations, a downhole object (e.g., a part or a broken-off tool piece or the like) can be unintentionally left in a well. The downhole object needs a particular tool that matches the downhole object's contoured surface for retrieval (e.g., by a fishing operation that uses the particular tool that matches the contoured surface). The downhole object's contoured surface is often measured with a lead impression block, which is relatively soft and can deform to retain the outer profile when pressed against the object.

### DESCRIPTION OF DRAWINGS

FIG. 1 illustrates a cross-sectional view of an example well system that includes a downhole tool;

FIGS. 2A-2C illustrate cross-sectional views of an example downhole tool;

FIG. 3A illustrates an example method for determining a shape of a downhole object using an downhole tool; and

FIG. 3B illustrates an example method for retrieving a downhole object using a digital mesh model.

### DETAILED DESCRIPTION

The present disclosure relates to determining a shape of a downhole object, such as a contoured surface of a downhole object, by using a downhole tool. The shape of the downhole object is determined and/or measured by generating an impression of the contoured surface (e.g., a three dimensional physical impression or representative data) in an impression device. In many instances, downhole objects are unintentionally left inside a well and need retrieval using a correct tool corresponding to the downhole objects' contoured surfaces. In some cases, a downhole object may have been intentionally left inside the well but may be of some unknown origin, shape, size, or otherwise. In some other cases as well, the downhole object may be a piece or part of another object, such as, for example, a piece of a broken casing or tool, debris that has fallen into the well, or other part.

In one general implementation, a downhole tool includes a housing including a base and an end open to an exterior of the housing opposite the base; and a plurality of moveable members at least partially enclosed within the housing, at least a portion of the moveable members contactingly mounted in the housing against at least one of a friction member or an adjacent moveable member, each moveable member in the portion of moveable members configured to translate between a first position extended a first distance from the base and a second position extended a variable second distance from the base less than the first distance based on contact of the moveable member with a downhole object.

In a first aspect combinable with the general implementation, the housing further includes an aperture adjacent to or in the base that is open to the exterior of the housing.

In a second aspect combinable with any of the previous aspects, each moveable member in the portion of moveable members is configured to remain set in the second position extended the variable second distance from the base less than the first distance based on a frictional contact with at least one adjacent moveable member or the friction member.

A third aspect combinable with any of the previous aspects further includes an actuation circuit including a memory and a battery, each moveable member of the portion of moveable members communicably coupled to the actuation circuit.

In a fourth aspect combinable with any of the previous aspects, the actuation circuit is configured to identify a signal from each moveable member of the portion of moveable members, the signal associated with the respective second position of each moveable member of the portion of moveable members.

In a fifth aspect combinable with any of the previous aspects, the actuation circuit is further configured to store the identified signals in the memory or transmit the identified signals to a terranean surface through the conduit.

In a sixth aspect combinable with any of the previous aspects, the actuation circuit is further configured to aggregate the identified signals; and generate a three dimensional model based on the aggregated signals, the three dimensional model defining a contoured surface of the downhole object, each of the identified signals defining a point on the contoured surface.

In a seventh aspect combinable with any of the previous aspects, each of the moveable members includes a moveable pin that includes a radial surface contactingly engaged against radial surfaces of adjacent moveable pins that are mounted in the housing.

In an eighth aspect combinable with any of the previous aspects, the friction member includes an interior surface of the housing.

In a ninth aspect combinable with any of the previous aspects, the plurality of moveable members include a non-toxic, lead-free material.

In another general implementation, a method performed with a downhole tool includes running the downhole tool into a wellbore; landing an open end of the downhole tool over a portion of a downhole object in the wellbore; contacting the portion of the downhole object with a plurality of moveable members contactingly mounted in the housing against at least one of an adjacent moveable member or a friction member; and based on the contact between the portion of the downhole object and the plurality of moveable members, moving the plurality of moveable members from first positions extended a first distance from a base of the housing toward respective second positions extended varying second distances from the base less than the first distance.

A first aspect combinable with the general implementation further includes including equalizing a pressure in the housing with an annulus pressure in the wellbore.

A second aspect combinable with any of the previous aspects further includes maintaining the plurality of moveable members in the respective second positions extended the varying second distances based on a frictional contact with the at least one of the adjacent moveable member or the friction member.

A third aspect combinable with any of the previous aspects further includes storing a plurality of values associated with the respective second positions of the moveable members in a memory module located in the downhole tool.

A fourth aspect combinable with any of the previous aspects further includes transmitting the plurality of values to a terranean surface through the conduit.

A fifth aspect combinable with any of the previous aspects further includes aggregating the plurality of values; and generating a three dimensional model based on the aggregated values, the three dimensional model defining a contoured surface of the downhole object, each of the values defining a point on the contoured surface.

In a sixth aspect combinable with any of the previous aspects, generating a three dimensional model includes generating a virtual mesh model.

A seventh aspect combinable with any of the previous aspects further includes selecting a fishing tool based on the contoured surface defined by the three dimensional model; and retrieving the downhole object from the wellbore with the selected fishing tool.

An eighth aspect combinable with any of the previous aspects further includes applying a jarring force to the downhole tool in a downhole direction; and based on the jarring force, further moving the plurality of moveable members to the respective second positions.

In another general implementation, a downhole tool system includes a slickline that is configured to extend from a terranean surface through a wellbore and a downhole tool that includes a connector configured to couple the downhole tool with the slickline; a housing coupled to the connector at a base end, the housing including an opening opposite the base; and an lead-free impression device mounted at least partially within the housing, the impression device configured to form an impression of a contoured surface of a downhole object based at least in part on contact between the downhole object and a face of the impression device.

In a first aspect combinable with the general implementation, the impression device includes a plurality of pins mounted in the housing, at least a portion of the pins frictionally mounted against an interior surface of the housing or against adjacent pins, each of the pins configured to axially translate between at least two fixed positions based on contact between the pin and a downhole object.

A second aspect combinable with any of the previous aspects further includes a memory communicably coupled to the plurality of pins and configured to store values associated with the at least two fixed positions for each of the pins.

A third aspect combinable with any of the previous aspects further includes a computing system configured to receive the values associated with the at least two fixed positions for each of the pins and model a surface contour of the downhole object based on the values.

Various implementations of a well tool in accordance with the present disclosure may include one, some, or all of the following features. For example, a well tool that includes an impression module composed of moveable members may be made of a non-toxic metal that can replace lead or other soft materials that may include health hazardous side effects. Large out-of-plane contour profile can be measured with the moveable members with a large and/or adjustable travel range in the axial direction. The impression recording of the contour profile can be clearer than that of a lead impression block. In some implementations, the moveable members can also convert physical impression into digital data for three dimensional model representations, which enables precise selection of fishing tool. In some implementations, the moveable members may record a more highly contoured surface, for example, as compared to lead impression blocks, which may have limited compressive capabilities (e.g., a quarter of inch or less).

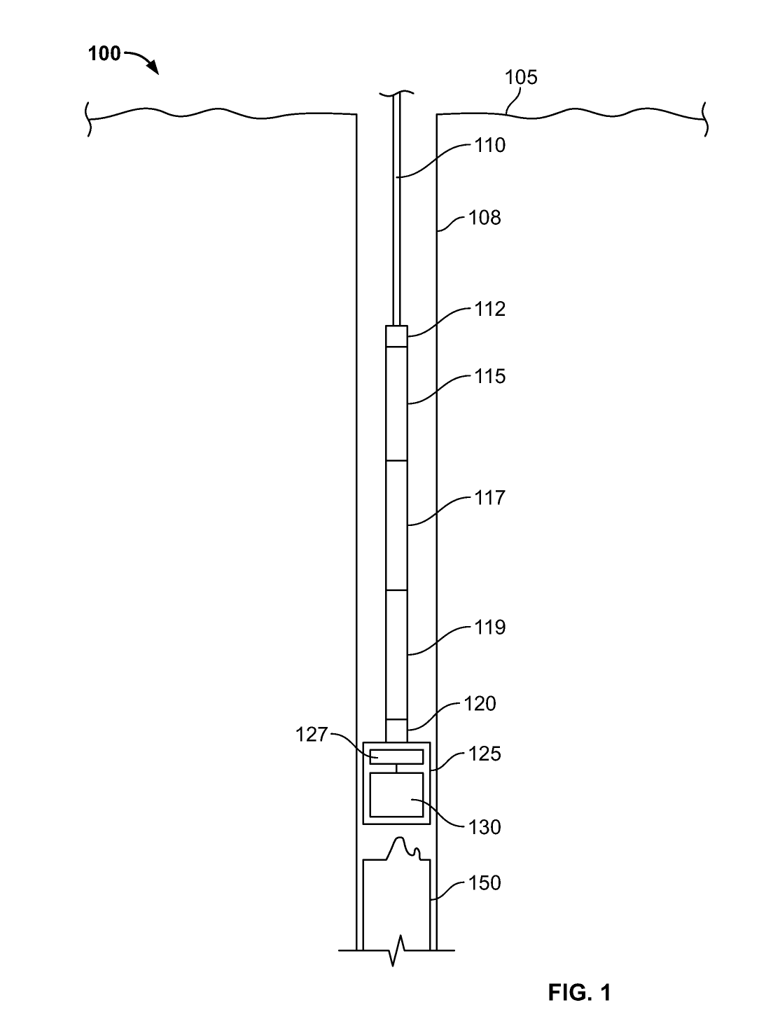

FIG. 1 illustrates a cross-sectional view of an example well system 100 that includes a downhole tool 125. The well system 100 is provided for convenience of reference only, and it should be appreciated that the concepts herein are applicable to a number of different configurations of well systems. As shown, the well system 100 includes a conduit 110 attached to the downhole tool 125 within a substantially cylindrical wellbore 108 that extends from a terranean surface 105 through one or more subterranean zones. The downhole tool 125 can be used to measure the outer profile of a downhole object 150. For example, the downhole tool 125 can be lowered and/or powered downward to contact with the downhole object 150 to obtain an impression. In FIG. 1, the wellbore 108 extends substantially vertically from the terranean surface 105. However, in other instances, the wellbore 108 can be of another position, for example, the wellbore 108 deviates horizontally in the subterranean zone, or entirely substantially vertical or slanted. The wellbore 108 may deviate in another manner than horizontal, such as multi-lateral, and/or may be of another position. When the wellbore 108 deviates, other auxiliary tools can be used together with the conduit 110 to drive the downhole tool 125 to impress against the downhole object 150.

As illustrated, the downhole tool 125 is coupled to the conduit 110, which can be a wireline, a slickline, an electric line, a coiled tubing, jointed tubing, or the like. In some implementations, the conduit 110 is a composite slickline having data communication wires, the slickline extending from the terranean surface 105 through the wellbore 108. The conduit 110 can couple to the downhole tool 125 using a rope socket 112, a plurality of stems 115 and 117, and a jar 119 (e.g., a hydraulic or mechanical jar, such as a fishing jar). The rope socket 112 allows the conduit 110 to engage or disengage with the downhole tool 125. The plurality of stems 115 and 117 are weight bars used in slickline operations. For example, when the conduit 110 enters the wellbore 108, the weight of the stems 115 and 117 can overcome the resistant effects of wellhead pressure and friction at the surface seal. The stems 115 and 117 can be solid steel stem, a special high-density stem (e.g., filled and sealed with lead, tungsten, or mercury alloys), or other high density materials. Although illustrated as two pieces of stems 115 and 117, more or less pieces of stems can be used depending on application. The jar 119 can apply compressive force to impress the downhole tool 125 against the downhole object 150. The connector 120 couples the downhole tool 125 to the jar 119 and conduit 110, and enables the conduit 110 to communicate signals with the downhole tool 125 as well as transfers jarring load from the jar 119 to the downhole tool 125.

In some implementations, the impression device 130 includes a number of moveable members mounted in the housing. The moveable members can be cylindrical pins made of lead-free, non-toxic metal material, such as stainless steel. Alternatively, the moveable members can be made of other rigid or semi-rigid materials that can, for example, withstand temperatures and/or pressure of the wellbore 108 without deformation. At least a portion of the pins are frictionally mounted against an interior surface of the housing, or against adjacent pins.

In some aspects, each pin (or multiple pins) is configured to axially translate between at least two fixed positions based on contact between the pin and the downhole object 150. The contoured surface of the downhole object 150 can be recorded by contoured surface area formed with the collective number of pins.

The illustrated downhole tool 125 includes an actuation circuit 127 and an impression device 130. The actuation circuit 127 and the impression device 130 are enclosed within a housing that is coupled with the connector 120 at a base end. Opposite to the base end, the housing has an opening for the impression device 130 to come into contact with the downhole object 150. The actuation circuit 127 includes control components and sensors to actuate the impression device 130 which is lead-free. The impression device 130 can form an impression of a contoured surface of the downhole object 150 based at least in part on contact between the downhole object 150 and a face of the impression device 130 (e.g., the bottom surface formed with a number of moveable members' lower end).

In some implementations, the actuation circuit 127 can further include a memory that can store values associated with the positions of each of the number of the pins, for sampling three dimensional model data points. The values may later be used to recreate a three dimensional model that represents the contoured surface of the downhole object 150. For example, a computing system can receive the values associated with the at least two fixed positions for each of the pins and model a surface contour of the downhole object based on the values.

In some implementations, the downhole tool 125 may not include the actuation circuit 127 or other integrated circuit or other electronics. In some implementations, the impression device 130 can form an impression of a contoured surface of the downhole object 150 based at least in part on contact between the downhole object 150 and a face of the impression device 130 (e.g., the bottom surface formed with a number of moveable members' lower end) and the impression (e.g., positions of the moveable members) may be mechanically stored. For example, the impression device 130 may retain a particular shape (e.g., particular positions of the moveable members) until the tool 125 is brought to the surface. Then, the shape may be observed and/or molded to determine the contoured surface of the object 150.

In some aspects, a mechanical interference may retain one or more of the moveable members in a particular position (e.g., subsequent to being impressed against a downhole object). For example, the interference may releasable hold (e.g., through friction or other techniques) one or more of the moveable members in the particular position so that the contoured surface of the downhole object may be observed and/or copied. In one example, a ratchet-type lock (or other locking mechanism) allows the moveable member to travel in one axial direction (e.g., toward a base of the tool) based on contact with the downhole object but substantially prevents movement in the opposite direction (e.g., until released from the lock).

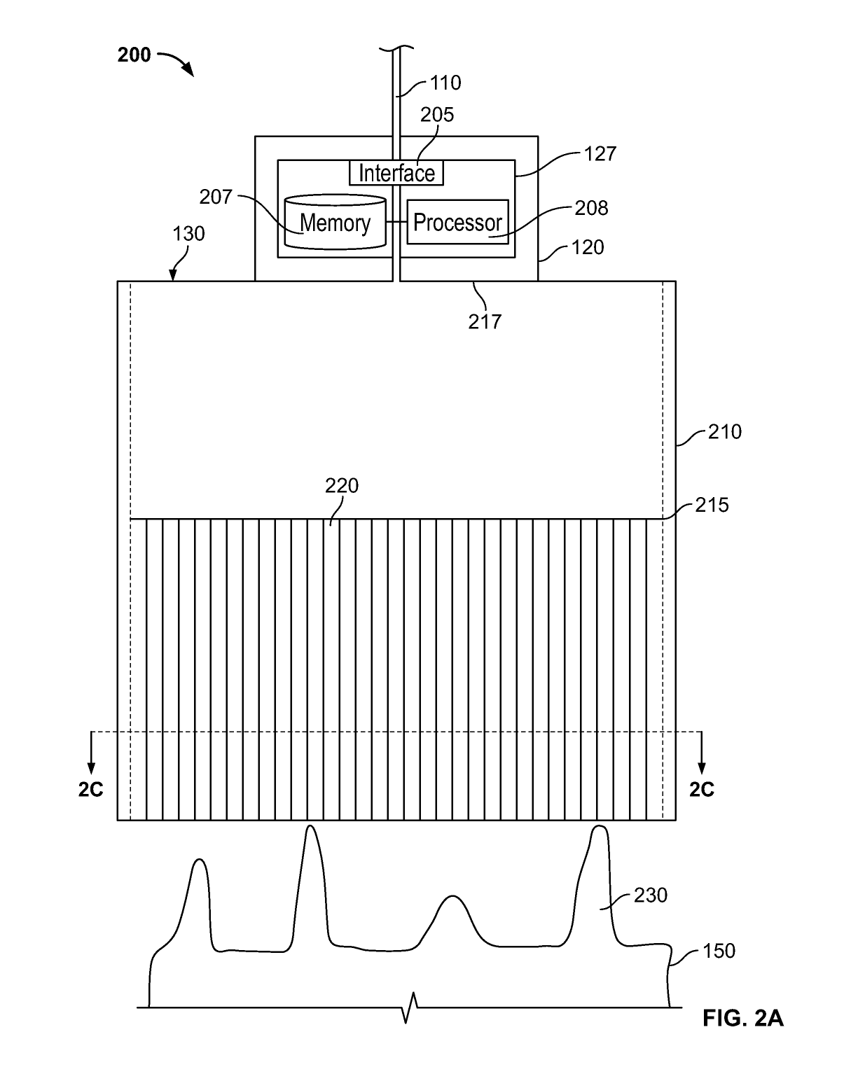

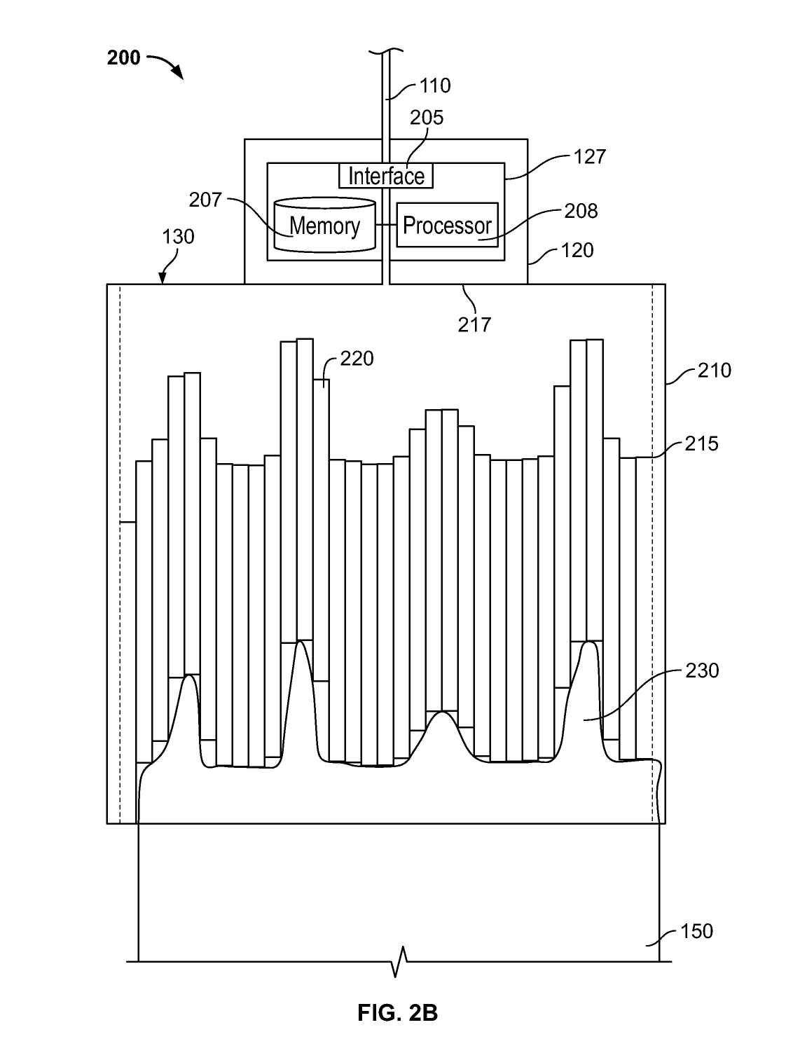

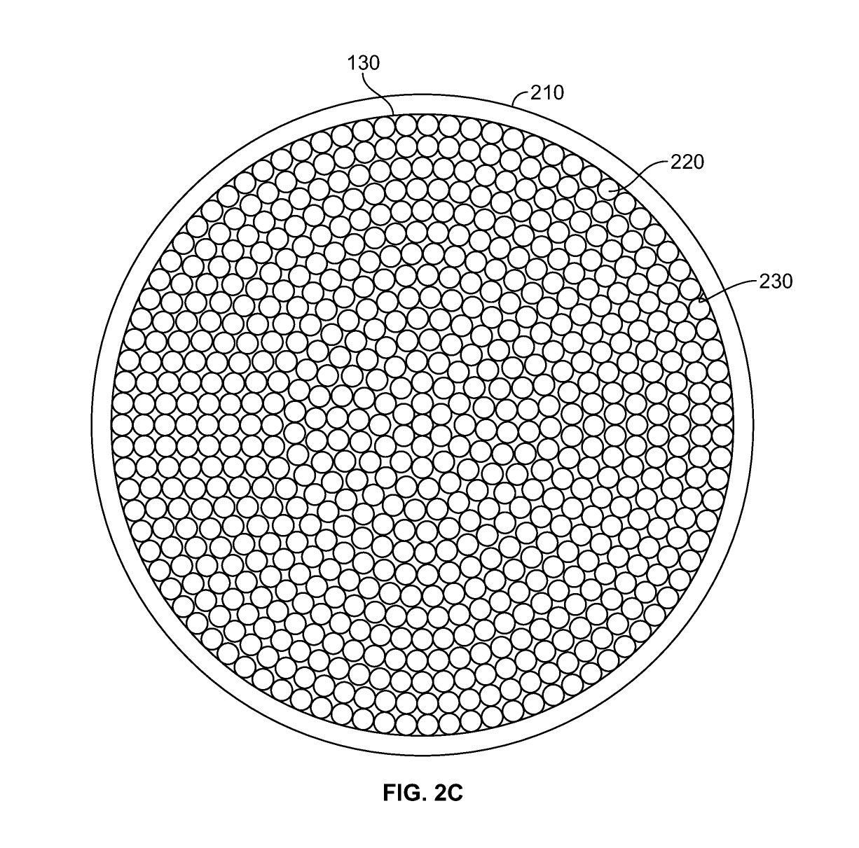

FIGS. 2A-2C illustrate cross-sectional views of an example downhole tool 200. FIG. 2A illustrates the downhole tool 200 at a default state; FIG. 2B illustrates the downhole tool 200 at a measurement state; and FIG. 2C illustrates the bottom view of the downhole tool 200. In FIG. 2A, the downhole tool 200 is coupled to the conduit 110 at the connector 120. The downhole tool 200 can further include the actuation circuit 127 and the impression device 130. The impression device 130 includes a housing 210 and a number of moveable members 220. The housing 210 is coupled to the connector 120. The housing 210 includes a retainer 215, a base 217 and an end open to an exterior of the housing 210 opposite the base 217. The retainer 215 can hold the moveable members 220 (e.g., by using friction) at a certain position against gravity or other unintentional forces. The moveable members 220 are at least partially enclosed within the housing 210. The moveable members 220 are contactingly mounted in the housing 210 against an interior surface of the housing 210, or against other adjacent moveable members 220.

In some implementations, the housing 210 further includes an aperture adjacent to or in the base 217 that is open to the exterior of the housing. The aperture allows pressure to be equalized between the inside and the outside of the housing 210 so that the moveable members 220 can accurately reflect the contoured surface of the downhole object 150 and not affected by pressure differences.

Each, or at least a portion, of the moveable members 220 is configured to translate between an initial position extended a default distance from the base 217 and an impression position extended a variable measurement distance from the base 217. The measurement distance may not be greater than the default distance and based on contact of the moveable member with the contoured surface 230 of the downhole object 150. For example, in FIG. 2B, the housing 210 is moved toward the downhole object 150. The moveable members 220 are translated according to the contoured surface 230 of the downhole object 150. The displacement moves each moveable member 220 from the original default distance to a measurement distance when the housing 210 is completely set at the end of the impression travel. Each moveable member 220 is configured to remain set (e.g., staying at certain position until intentional actuation) in the impression position extended the variable measurement distance from the base 217 less than the first distance based on a frictional contact with at least one adjacent moveable member or the interior surface of the housing.

Although in FIGS. 2A and 2B, the moveable members 220 are enclosed within the housing 210, other configurations are possible. For example, the housing 210 may partially enclose a portion of the moveable members 220, and allow the perimeter of the impression device 130 include moveable members 220. Other configuration of the moveable members are possible.

In FIGS. 2A and 2B, the illustrated actuation circuit 127 further includes an interface 205, a memory 207, and a processor 208. In some implementations, the actuation circuit 127 may further include a power source (e.g., a battery) or a connection to an external power source (e.g., through the conduit 110). Each moveable member 220 can be communicably coupled to the actuation circuit 170. For example, the retainer 215 may be integrated with (e.g., may include) a set of position sensors to identify the movement of each moveable member 220. The set of position sensors can communicate the measurement with the actuation circuit 170.

In some aspects, a linear position sensor (e.g., battery powered sensor) may be used to communicate the measurement with the actuation circuit 170. As another example, each moveable member 220 may include a hydraulic cylinder that records changes in pressure when the moveable member 220 is moved (e.g., in contact with the downhole object). As another example, one or more strain gauges may be arranged to record an inward force on the moveable member 220, which may then be converted to a length of movement of the members 220 and provided to the actuation circuit 170. In any event, data recorded from the moveable members 220 may be used to generate a three-dimensional image of at least a part (e.g., an uphole facing surface) of the downhole object).

The actuation circuit 170 can identify a signal from each moveable member 220. The signal is associated with the respective impression position of each moveable member 220. The actuation circuit 127 can store the identified signals in the memory 207 and/or transmit the identified signals to a computing device at the terranean surface 105 through the conduit 110.

In some implementations, the actuation circuit 127 can aggregate the identified signals and generate a three dimensional model based on the aggregated signals. The three dimensional model may define a contoured surface of the downhole object 105. For example, the signals describing respective pins'set positions can be aggregated at the actuation circuit 127 for calculating a virtual mesh model describing the contoured surface of the downhole object 150. The virtual mesh model may be represented in a single three dimensional computer aided design file and sent to a receiving computing device at the surface 105. Alternatively, the signals describing respective pins'set positions can be communicated serially to the receiving computing device at the surface 105. The receiving computing device can then derive and generate (or regenerate) a virtual mesh model from the serial flow of signals.

In some implementations, each of the moveable members 220 can be a cylindrical pin, as shown in FIG. 2C. Each pin has a radial surface contactingly engaged against the radial surfaces of other adjacent moveable pins. The cylindrical pins fill inside the housing 210. The diameter of the cylindrical pins can determine the measurement resolution of the impression device 130. For example, a small diameter corresponds to a large number of pins filling inside the housing 210 and a corresponding high measurement resolution. The length of the cylindrical pins and the allowable travel distance relative to the retainer 215 can determine the measureable out-of-plane variation of the contoured profile of the downhole object 150. For example, the longer the cylindrical pins and the longer travel distance relative to the retainer 215 is allowed, the larger out-of-plane variation of the contoured profile can be measured.

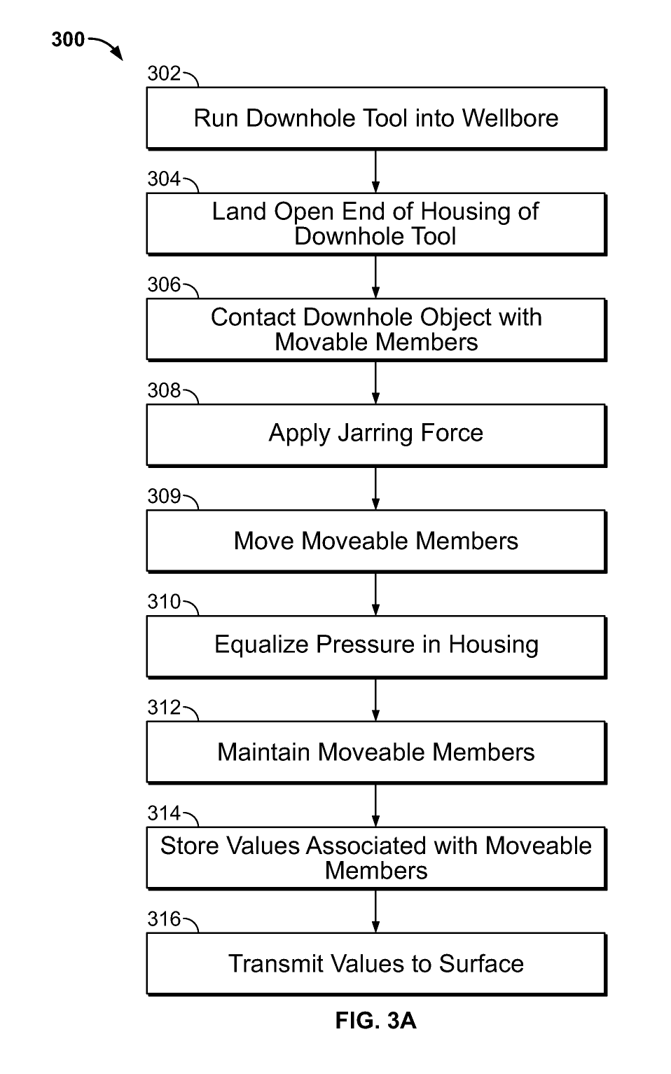

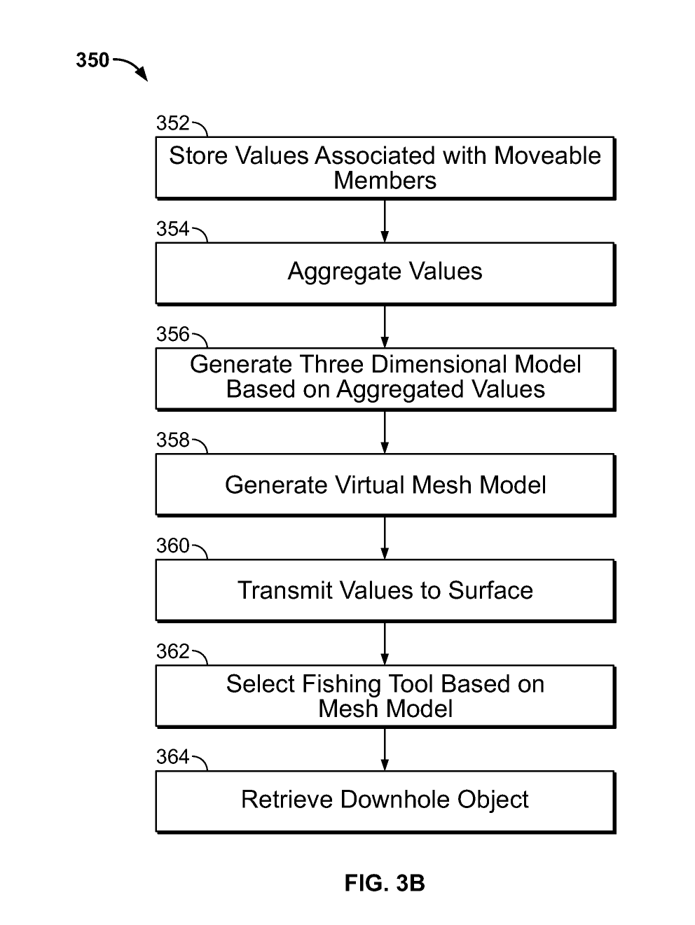

FIG. 3A illustrates an example method 300 for determining a shape of a downhole object using a downhole tool. At 302, the downhole tool is run into a wellbore on a conduit, which is coupled to a housing of the downhole tool. The housing includes an impression device that can measure the contoured surface of the downhole tool. The impression device includes a number of moveable members that can translate axially. The moveable members may be connected with an actuation circuit to record the position of each moveable member. The movable members are exposed to the downhole object through an open end (e.g., at the bottom) of the housing.

At 304, the open end of the housing of the downhole tool is landed on top of a portion of the downhole object in the wellbore. The downhole tool may be landed by lowering the conduit and/or powered downward by additional devices.

At 306, the moveable members contact the contoured surface of the downhole object. In some implementations, the moveable members are mounted in the housing against an interior surface of the housing or against adjacent moveable members. The moveable members can move relative to the housing and each other. When impressed against a portion the downhole object, the moveable members form a displaced shape that matches (e.g., exactly or substantially) the contoured surface (e.g., as shown in FIG. 2B).

At 308, jarring force is applied to the downhole tool in a downhole direction. The jarring force can be actuated from a jar coupled with the connection to the housing, such as the jar 119 of FIG. 1. The jarring force can push the housing as well as the moveable members to a more accurate impression.

At 309, the moveable members are moved based on the contact between the portion of the downhole object and the plurality of moveable members. The moveable members are moved from original positions extended a default distance from a base of the housing toward respective set positions extended varying measurement distances from the base less than the default distance. In some implementations, the moveable members can be moved based on the jarring force to the respective set positions.

At 310, the pressure in the housing is equalized with an annulus pressure in the wellbore. The pressure can be equalized by opening an aperture adjacent to or in the base that is open to the exterior of the housing. In some aspects, step 310 may be performed substantially simultaneous with other steps (e.g., steps 302 or 304). For example, in some aspects, the tool may be passively pressure-balanced (e.g., open on both uphole and downhole ends) in the wellbore.

At 312, the moveable members' positions are maintained in the respective set positions extended the varying measurement distances based on a frictional contact with at least one adjacent moveable member or the interior surface of the housing. In some implementations, the downhole tool with the moveable members in set positions can be retrieved at the surface. The physical position of the moveable members can be directly used for determining the contoured surface of the downhole object and for selecting the correct tool for retrieving the downhole object. In some implementation, as described in the following steps, a digital representation (or its associated data) of the moveable members can be sent for determining the contoured surface of the downhole object.

At 314, values associated with the moveable members are stored in a memory module located in the downhole tool. For example, the values associated with the respective set positions of the moveable members are stored at the memory of the actuation circuit in the downhole tool.

At 316, the values associated with the moveable members are transmitted to the surface through the conduit for determination of the correct retrieval tool. In some implementations, the values can be used to create a three dimensional model at the surface. In other instances, the values can first be aggregated to determine a three dimensional model and then sent to the surface, as discussed below.

FIG. 3B illustrates an example method 350 for retrieving a downhole object using a digital mesh model. The method 350 can be a subroutine within the method 300. For example, the method 350 can be applied at the end of the method 300. At 352, values associated with moveable members are stored at a memory module of the downhole tool, such as the memory of the actuation circuit.

At 354, the values are aggregated to include a complete contoured surface of the measured downhole object. The aggregation can further include information identifying each moveable member's respective set position in relation to the housing.

At 356, a three dimensional model is generated for the contoured surface of the downhole object based on the aggregated values. The three dimensional model can define a contoured surface of the downhole object such that each of the values defining a point on the contoured surface.

At 358, a virtual mesh model is generated. The virtual mesh model may, based on a particular curve fitting algorithm, extrapolate and/or interpolate data points to more accurately describe the actual contoured surface of the downhole object.

At 360, the virtual mesh model and its associated data values are transmitted to the surface through the conduit. In some implementations, the virtual mesh model may be received and processed by another computing device at the surface. In other instances, the virtual mesh model may be directly used/displayed for determining the contoured surface of the downhole tool.

At 362, a fishing tool is selected based on the mesh model. The fishing tool can be selected based on the contoured surface defined by the three dimensional mesh model.

At 364, the fishing tool is used to retrieve the downhole object from the wellbore.

A number of examples have been described. Nevertheless, it will be understood that various modifications may be made. For example, configuration of the moveable members and the housing of the downhole tool can be varied. The moveable members may be completely or partially enclosed inside the housing. In some implementations, some of the moveable members may be configured outside the housing. The cross section profile of each moveable member may also be different from the illustration. For example, the moveable members may be pins having a rectangular, a hexagonal, a square, or other different cross sectional shapes. Accordingly, other examples are within the scope of the following claims.

What is claimed is:

1. A downhole tool, comprising:
a housing comprising a base and an end open to an exterior of the housing opposite the base; and
a plurality of moveable members at least partially enclosed within the housing, at least a portion of the moveable members contactingly mounted in the housing against at least one of a friction member or an adjacent moveable member, each moveable member in the portion of moveable members configured to translate between a first position extended a first distance from the base and a second position extended a variable second distance from the base less than the first distance based on contact of the moveable member with a downhole object.

2. The downhole tool of claim 1, wherein the housing further comprises an aperture adjacent to or in the base that is open to the exterior of the housing.

3. The downhole tool of claim 1, wherein each moveable member in the portion of moveable members is configured to remain set in the second position extended the variable second distance from the base less than the first distance based on a frictional contact with at least one adjacent moveable member or the friction member.

4. The downhole tool of claim 1, further comprising an actuation circuit comprising a memory and a battery, each moveable member of the portion of moveable members communicably coupled to the actuation circuit.

5. The downhole tool of claim 4, wherein the actuation circuit is configured to identify a signal from each moveable member of the portion of moveable members, the signal associated with the respective second position of each moveable member of the portion of moveable members.

6. The downhole tool of claim 5, wherein the actuation circuit is further configured to store the identified signals in the memory or transmit the identified signals to a terranean surface through the conduit.

7. The downhole tool of claim 5, wherein the actuation circuit is further configured to:
aggregate the identified signals; and
generate a three dimensional model based on the aggregated signals, the three dimensional model defining a contoured surface of the downhole object, each of the identified signals defining a point on the contoured surface.

8. The downhole tool of claim 1, wherein each of the moveable members comprises a moveable pin that comprises a radial surface contactingly engaged against radial surfaces of adjacent moveable pins that are mounted in the housing.

9. The downhole tool of claim 1, wherein the friction member comprises an interior surface of the housing.

10. The downhole tool of claim 1, wherein the plurality of moveable members comprise a non-toxic, lead-free material.

11. A method performed with a downhole tool, comprising:
running the downhole tool into a wellbore;
landing an open end of the downhole tool over a portion of a downhole object in the wellbore;
contacting the portion of the downhole object with a plurality of moveable members contactingly mounted in the housing against at least one of an adjacent moveable member or a friction member; and
based on the contact between the portion of the downhole object and the plurality of moveable members, moving the plurality of moveable members from first positions extended a first distance from a base of the housing toward respective second positions extended varying second distances from the base less than the first distance.

12. The method of claim 11, further comprising equalizing a pressure in the housing with an annulus pressure in the wellbore.

13. The method of claim 11, further comprising maintaining the plurality of moveable members in the respective second positions extended the varying second distances based on a frictional contact with the at least one of the adjacent moveable member or the friction member.

14. The method of claim 13, further comprising storing a plurality of values associated with the respective second positions of the moveable members in a memory module located in the downhole tool.

15. The method of claim 14, further comprising transmitting the plurality of values to a terranean surface through the conduit.

16. The method of claim 14, further comprising:
aggregating the plurality of values; and
generating a three dimensional model based on the aggregated values, the three dimensional model defining a contoured surface of the downhole object, each of the values defining a point on the contoured surface.

17. The method of claim 16, wherein generating a three dimensional model comprises generating a virtual mesh model.

18. The method of claim 17, further comprising:
selecting a fishing tool based on the contoured surface defined by the three dimensional model; and
retrieving the downhole object from the wellbore with the selected fishing tool.

19. The method of claim 11, further comprising:
applying a jarring force to the downhole tool in a downhole direction; and
based on the jarring force, further moving the plurality of moveable members to the respective second positions.

20. A downhole tool system, comprising:
a slickline that is configured to extend from a terranean surface through a wellbore; and
a downhole tool, comprising:
a connector configured to couple the downhole tool with the slickline;
a housing coupled to the connector at a base end, the housing comprising an opening opposite the base; and
an lead-free impression device mounted at least partially within the housing, the impression device configured to form an impression of a contoured surface of a downhole object based at least in part on contact between the downhole object and a face of the impression device.

21. The downhole tool system of claim 20, wherein the impression device comprises a plurality of pins mounted in the housing, at least a portion of the pins frictionally mounted against at least one of an interior surface of the housing or against adjacent pins, each of the pins configured to axially translate between at least two fixed positions based on contact between the pin and a downhole object.

22. The downhole tool system of claim 21, further comprising a memory communicably coupled to the plurality of pins and configured to store values associated with the at least two fixed positions for each of the pins.

23. The downhole tool system of claim 21, further comprising:
a computing system configured to receive the values associated with the at least two fixed positions for each of the pins and model a surface contour of the downhole object based on the values.
